(19) United States
(12) Patent Application Publication
(10) Pub. No.: US 2025/0013082 A1
(43) Pub. Date: Jan. 9, 2025

(54) DISPLAY MODULE, DRIVING METHOD, AND DISPLAY DEVICE

(71) Applicant: HKC CORPORATION LIMITED, Shenzhen (CN)

(72) Inventors: Huayin Wen, Shenzhen (CN); Lidan Ye, Shenzhen (CN)

(21) Appl. No.: 18/741,821

(22) Filed: Jun. 13, 2024

(30) Foreign Application Priority Data
Jul. 7, 2023 (CN) 202310826447.3

(51) Int. Cl. G02F 1/01; G02F 1/061

(52) U.S. Cl. CPC G02F 1/0147; G02F 1/061

(57) ABSTRACT

A display module, a driving method, and a display device are disclosed. The display module includes a light adjustment layer arranged on a side of a lower polarizer facing away from the display layer. The light adjustment layer includes a void layer disposed adjacent to the lower polarizer, a polymer material layer disposed on a side of the void layer facing away from the lower polarizer, and an isolation film disposed between the polymer material layer and the void layer. The polymer material layer can switch between a first and a second state. When the polymer material layer is in the first state, the isolation film has a concave arc-shaped structure, and the display module is in an anti-peep mode. When the polymer material layer is in the second state, the isolation film has a convex arc-shaped structure, and the display module is in a wide viewing angle mode.

### CROSS-REFERENCE TO RELATED APPLICATIONS

This application claims the priority and benefit of Chinese patent application number 2023108264473, titled “Display Module, Driving Method, and Display Device” and filed Jul. 7, 2023 with China National Intellectual Property Administration, the entire contents of which are incorporated herein by reference.

### TECHNICAL FIELD

This application relates to the field of display technology, and more particularly relates to a display module, a driving method, and a display device.

### BACKGROUND

The description provided in this section is intended for the mere purpose of providing background information related to the present application but doesn't necessarily constitute prior art.

With the continuous development of display technology, the viewing angle of the display panel is getting wider and wider. The viewing angle of a current display panel is close to 180 degrees, and users can watch the content displayed on the display panel from various angles, basically realizing a viewing experience without dead angles. However, in public places, due to the increased viewing angle, it also brings unnecessary troubles to the user, including privacy leakage.

In order to avoid the leakage of privacy, an anti-peep film may be added to the display screen to realize the convergence of the viewing angle. However, while effectively preventing peeping, it also brings about the problems of decreased brightness of the display panel and poor display effect. Furthermore, the anti-peep film is only capable of one-way anti-peeping. When the user needs to share the displayed content with other users, it is impossible to switch from the anti-peep mode back to the normal mode, thus reducing the user experience.

### SUMMARY

In view of the above, it is one purpose of this application to provide a display module, a driving method, and a display device that can switch between the anti-peep mode and the wide viewing angle mode by controlling the polymer material layer and the isolation film to meet the user's needs and improve the user's experience.

This application discloses a display module, including a display layer, an upper polarizer, and a lower polarizer. The upper polarizer is arranged on a light-emitting surface side of the display layer. The lower polarizer is arranged on a light incident surface side of the display layer. The display module further includes a light adjustment layer. The light adjustment layer is disposed on a side of the lower polarizer facing away from the display layer. The light adjustment layer is divided into multiple partitions. Each of the partitions includes a void layer and a polymer material layer. The void layer is arranged close to the lower polarizer. The polymer material layer is disposed on a side of the void layer facing away from the lower polarizer. There is disposed an isolation film between the polymer material layer and the void layer. The polymer material layer includes a first state and a second state. The polymer material layer is operative to switch between the first state and the second state. When the polymer material layer is in the first state, the isolation film has a concave arc-shaped structure, and the display module is in an anti-peep mode. When the polymer material layer is in the second state, the isolation film has a convex arc-shaped structure, and the display module is in a wide viewing angle mode.

In some embodiment, the light adjustment layer further includes a heating electrode. The heating electrode is arranged on a side of the polymer material layer facing away from the void layer. The heating electrode is energized to heat the polymer material layer, so that the polymer material layer switches from the first state to the second state when heated.

In some embodiment, a separation wall is disposed between the partitions. The isolation film in each of the partitions is respectively fixed to the separation walls disposed at the left and right ends of the partition. The separation wall is made of a transparent material.

In some embodiment, each separation wall includes a through hole in an area corresponding to the void layer.

In some embodiment, the light adjustment layer further includes a first thermal insulation layer and a second thermal insulation layer. The first thermal insulation layer is disposed on the side of the void layer adjacent to the lower polarizer. The second thermal insulation layer is disposed on the side of the polymer material layer facing away from the void layer. The first thermal insulation layer and the second thermal insulation layer are each made of a transparent material.

In some embodiment, the heating electrode includes a plurality of sub-heating electrodes. Each of the sub-heating electrodes is disposed corresponding to one of the partitions. The position of the sub-heating electrode corresponds to a central part of the respective partition.

In some embodiment, a polymer material is disposed in the polymer material layer, and the polymer material is made of a material with a relatively high thermal expansion coefficient.

In some embodiment, the isolation film is a polyethylene terephthalate film.

This application further discloses a driving method, applied to the display module as mentioned above, the driving method including the following operations:
in the anti-peep mode, the polymer material layer is in the first state, and the isolation film has a concave arc-shaped structure;
in the wide viewing angle mode, the polymer material layer is in the second state, and the isolation film has a convex arc-shaped structure;
wherein when the display module is in the anti-peep mode, the polymer material layer is in the first state, the isolation film has a concave arc-shaped structure, and after the light is emitted into the polymer material layer, it converges under the action of the isolation film to form the anti-peep mode; when the display module is in the wide viewing angle mode, the polymer material layer is in the second state, the isolation film has a convex arc-shaped structure, and the light is scattered under the action of the isolation film after being emitted into the polymer material layer thus forming the wide viewing angle mode.

The present application further discloses a display device, which includes a driving circuit and the above-mentioned display module, where the driving circuit drives the display module.

The display module of this application controls the polymer material layer to switch between the first state and the second state, thereby controlling the isolation film to switch between the concave arc-shaped structure and the convex arc-shaped structure, so that the display module can be switched between the anti-peep mode and the wide viewing angle mode, allowing the user to switch between the anti-peep mode and the wide viewing angle mode according to his/her own viewing needs, meeting user needs and improving user experience.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principle of the present application in conjunction with the text description. Apparently, the drawings in the following description merely represent some embodiments of the present disclosure, and for those having ordinary skill in the art, other drawings may also be obtained based on these drawings without investing creative efforts. A brief description of the accompanying drawings is provided as follows.

FIG. 1 is a schematic diagram of a display module in anti-peep mode according to a first embodiment of the present application.

FIG. 2 is a schematic diagram of a display module in wide viewing angle mode according to the first embodiment of the present application.

FIG. 3 is a schematic diagram of a light path in the anti-peep mode according to the first embodiment of the present application.

FIG. 4 is a schematic diagram of a light path in the wide viewing angle mode according to the first embodiment of the present application.

FIG. 5 is a schematic diagram of a display module in anti-peep mode according to a second embodiment of the present application.

FIG. 6 is a schematic diagram of a display module in wide viewing angle mode according to the second embodiment of the present application.

FIG. 7 is a schematic diagram of a light path in the anti-peep mode according to the second embodiment of the present application.

FIG. 8 is a schematic diagram of a light path in the wide viewing angle mode according to the second embodiment of the present application.

FIG. 9 is a schematic diagram of the second embodiment of the present application after a first thermal insulation layer and a second thermal insulation layer are disposed.

FIG. 10 is a schematic diagram of the second embodiment of the present application after a sub-heating electrode is installed.

FIG. 11 is a flowchart of a driving method according to a third embodiment of the present application.

FIG. 12 is a schematic diagram of a display device according to a fourth embodiment of the present application.

In the drawings: 100. Display module; 110. Display layer; 120. Upper polarizer; 130. Lower polarizer; 200. Light adjustment layer; 210. Void layer; 220. Polymer material layer; 221. Polymer material; 230. Isolation film; 240. Partition; 250. Heating electrode; 251. Sub-heating electrode; 260. Separation wall; 261. Through hole; 270. First thermal insulation layer; 280. Second thermal insulation layer; 300. Drive circuit; 400. Display device; 500. Backlight module.

### DETAILED DESCRIPTION OF EMBODIMENTS

It should be understood that the terms used herein, the specific structures and function details disclosed herein are intended for the mere purposes of describing specific embodiments and are representative. However, this application may be implemented in many alternative forms and should not be construed as being limited to the embodiments set forth herein.

As used herein, terms “first”, “second”, or the like are merely used for illustrative purposes, and shall not be construed as indicating relative importance or implicitly indicating the number of technical features specified. Thus, unless otherwise specified, the features defined by “first” and “second” may explicitly or implicitly include one or more of such features. Terms “multiple”, “a plurality of”, and the like mean two or more. Term “comprising”, “including”, and any variants thereof mean non-exclusive inclusion, so that one or more other features, integers, steps, operations, units, components, and/or combinations thereof may be present or added.

In addition, terms “center”, “transverse”, “up”, “down”, “left”, “right”, “vertical”, “horizontal”, “top”, “bottom”, “inside”, “outside”, or the like are used to indicate orientational or relative positional relationships based on those illustrated in the drawings. They are merely intended for simplifying the description of the present disclosure, rather than indicating or implying that the device or element referred to must have a particular orientation or be constructed and operate in a particular orientation. Therefore, these terms are not to be construed as restricting the present disclosure.

Furthermore, as used herein, terms “installed on”, “mounted on”, “connected to”, “coupled to”, “connected with”, and “coupled with” should be understood in a broad sense unless otherwise specified and defined. For example, they may indicate a fixed connection, a detachable connection, or an integral connection. They may denote a mechanical connection, or an electrical connection. They may denote a direct connection, a connection through an intermediate, or an internal connection between two elements. For those of ordinary skill in the art, the specific meanings of the above terms as used in the present application can be understood depending on specific contexts.

The present application will be described in detail below with reference to the accompanying drawings and optional embodiments. It should be noted that, should no conflict is present, the various embodiments or technical features described below can be combined arbitrarily to form new embodiments.

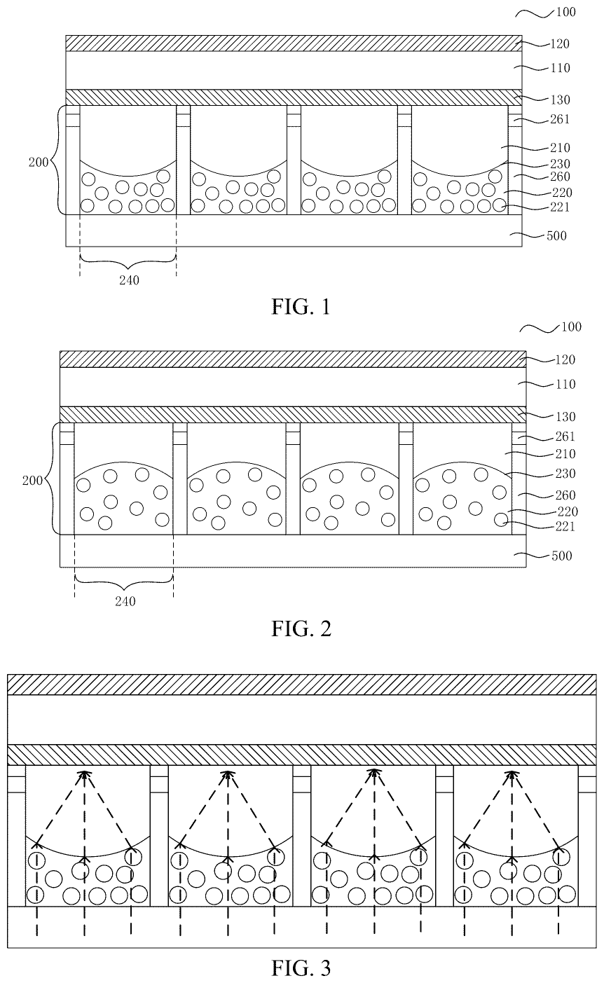

As illustrated in FIGS. 1 to 4, as a first embodiment of the present application, a display module 100 is disclosed. The display module 100 includes a display layer 110, an upper polarizer 120, and a lower polarizer 130. The upper polarizer 120 is disposed on a light-emitting surface side of the display layer 110. The lower polarizer 130 is disposed on a light incident surface side of the display layer 110. The display module 100 further includes a light adjustment layer 200. The light adjustment layer 200 is disposed on the side of the lower polarizer 130 facing away from the display layer 110. The light adjustment layer 200 is divided into multiple partitions 240. Each of the partitions 240 includes a void layer 210 and a polymer material layer 220. The void layer 210 is disposed adjacent to the lower polarizer 130. The polymer material layer 220 is disposed on the side of the void layer 210 facing away from the lower polarizer 130. An isolation film 230 is disposed between the polymer material layer 220 and the void layer 210. The polymer material layer 220 has a first state and a second state. The polymer material layer 220 switches between the first state and the second state. When the polymer material layer 220 is in the first state, the isolation film 230 has a concave arc-shaped structure, and the display module 100 is in the anti-peep mode. When the polymer material layer 220 is in the second state, the isolation film 230 has a convex arc-shaped structure, and the display module 100 is in a wide viewing angle mode. The first state of the polymer material layer 220 is a normal state. At this time, the polymer material layer 220 is immobile, and the isolation film 230 is in the shape of a concave arc. The second state of the polymer material layer 220 is an expanded state. At this time, the polymer material layer 220 expands to push up the isolation film 230, so that the isolation film 230 has a convex arc-shaped structure. Of course, the first state and the second state of the polymer material layer are not limited thereto. The first state and the second state of the polymer material layer only need to satisfy the realization of the state switching of the isolation film, and there is no limit thereto. Designers can choose the design based on actual situations.

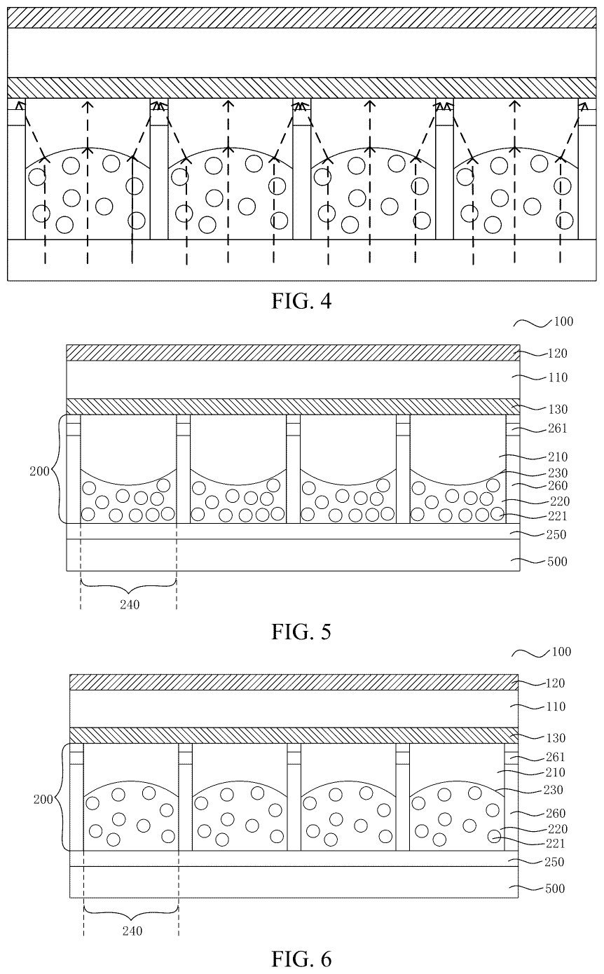

When the display module 100 of this embodiment is in use, when the display module 100 operates in the anti-peep mode, the polymer material layer 220 is in the first state, and the isolation film 230 has a concave arc-shaped structure. As illustrated in FIG. 1, the light provided by the backlight module 500 will first be emitted into the polymer material layer 220. Subsequently, under the action of the isolation film 230 between the polymer material layer 220 and the void layer 210, the light corresponding to each partition 240 may converge at the center of the isolation film 230. That is, most of the light rays are concentrated in the central area of each partition 240. Then the light rays pass through the void layer 210 and the lower polarizer 130 to be incident into the display layer 110, providing light to the display layer 110 to realize an anti-peep mode. The light path is illustrated in FIG. 3. The amount of light rays in the central area of the display layer 110 corresponding to the partition 240 is greater than the amount of light rays in the edge areas of the display layer 110 corresponding to the partition 240. Thus, the user can only view the display content within the viewing angle perpendicular to the light incident surface of the display module 100, and cannot view the display content from other viewing angles. When the display module 100 operates in the wide viewing angle mode, the polymer material layer 220 is in the second state. The expanded polymer material layer 220 lifts up the isolation film 230 so that the isolation film 230 has a convex arc-shaped structure. As illustrated in FIG. 2, the light provided by the backlight module 500 will first be emitted into the polymer material layer 220. Subsequently, under the action of the isolation film 230, the light rays corresponding to each partition 240 may be scattered. The light rays are diverged and emitted to spread throughout the entire partition 240 and even enter an adjacent partition 240. Then the light rays pass through the void layer 210 and the lower polarizer 130 to be incident into the display layer 110, providing light to the display layer 110 to realize a wide viewing angle mode. The light path is shown in FIG. 4. As such, the user can view display content from multiple angles. The display module 100 of this embodiment may control the isolation film 230 to switch between the first state and the second state, thereby controlling the isolation film 230 to switch between the concave arc-shaped structure and the convex arc-shaped structure, so that the display module 100 can be switched between the anti-peep mode and the wide viewing angle mode, allowing the user to switch between anti-peep mode and wide viewing angle mode according to his/her own viewing needs, thereby meeting user's needs and improving user experience. It should be noted that the isolation film 230 may be made of a transparent material, and the isolation film 230 may be a polyethylene glycol terephthalate (PET) film to achieve good light transmittance.

Further, in order to achieve better isolation between the partitions 240, separation walls 260 may be disposed between the multiple partitions 240. The isolation film 230 in each of the partitions 240 is fixed to the separation walls 260 located at the left and right ends of the partition 240, so that when the polymer material layer 220 is in the second state, the isolation film 230 can be lifted up to form the convex arc-shaped structure. The separation wall 260 may be made of transparent material. In this embodiment, in order to ensure superior light transmittance, the separation wall 260 may be made of glass. The light may directly pass through the separation wall 260 to enter the adjacent partition 240 or directly pass through the separation wall 260 to enter the display layer 110. Both ends of the isolation film 230 may be fixed to the separation walls 260 by gluing. Of course, the separation wall 260 is not limited to being made of glass, but may also be made of other transparent materials. There are no limitations thereto, and designers can choose the design depending on the actual situations.

The separation wall 260 includes a through hole 261 in an area corresponding to the void layer 210. The through holes 261 communicate the void layers 210 of the multiple partitions 240 to each other, and connect the void layers 210 of the partitions 240 to the outside world. When the polymer material layer 220 is in the second state, the polymer material layer 220 may lift the isolation film 230 to form the convex arc-shaped structure. At this time, the volume of the void layer 210 is reduced, and the air inside the void layer 210 may be discharged from the void layer 210 into the outside through the through holes 261 defined in the separation walls 260 to avoid the problem that the polymer material layer 220 lifts up the isolation film 230 causing the air pressure of the void layer 210 to change thereby causing damage to the light adjustment layer 200. Furthermore, because the air pressure of the void layer 210 will not change, the volume between each partition 240 will not change, thus avoiding the problem of rupture of the light adjustment layer 200. Of course, a gap layer may also be provided to maintain the air pressure balance of the light adjustment layer 200. The gap layer only needs to be disposed on the void layer 210 in the light adjustment layer 200 so that the air in the void layer 210 can be discharged through the gap layer when the display module 100 is in the wide viewing angle mode. It should be noted that the gap layer may be made of a porous material. The gap layer covers the void layer 210 and is connected to the outside world, and the air in the void layer 210 can be transferred to the outside world through the pores of the gap layer.

As illustrated in FIGS. 5 to 8, as a second embodiment of the present application, which is an improvement of the first embodiment of the present application, a display module 100 is disclosed. The light adjustment layer 200 further includes a heating electrode 250. The heating electrode 250 is disposed on a side of the polymer material layer 220 facing away from the void layer 210. The heating electrode 250 is energized to heat the polymer material layer 220, so that the polymer material layer 220 switches from the first state to the second state when heated;

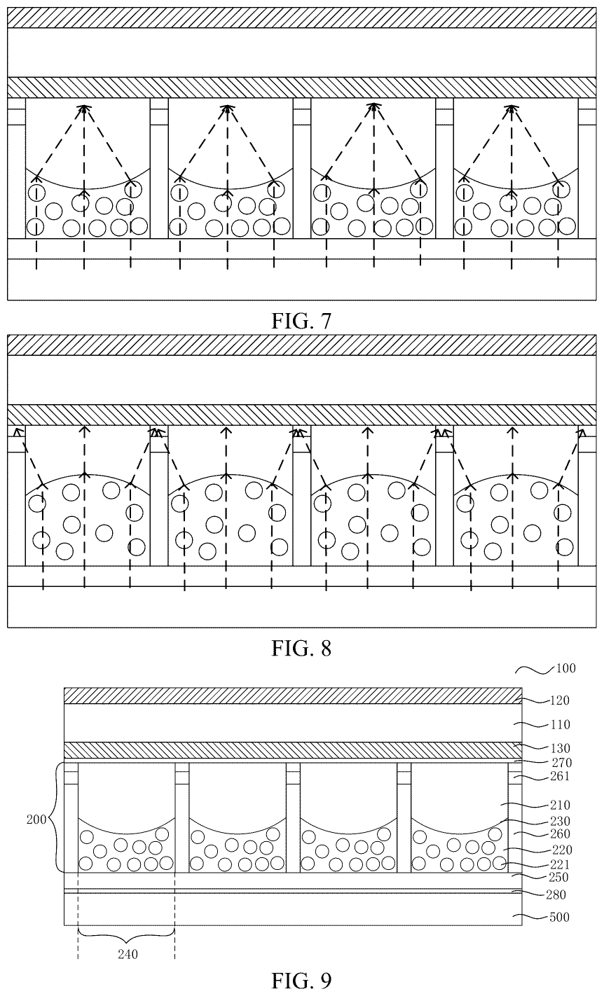

When the display module 100 of this embodiment is in use, when the display module 100 is in the anti-peep mode, as illustrated in FIG. 5, the heating electrode 250 is not energized. The polymer material layer 220 is in the first state, and the isolation film 230 has a concave arc-shaped structure. The light provided by the backlight module 500 will first be emitted into the polymer material layer 220. Subsequently, under the action of the isolation film 230 between the polymer material layer 220 and the void layer 210, the light rays corresponding to each partition 240 are concentrated in the central area of each partition 240. Then the light rays pass through the void layer 210 and the lower polarizer 130 to be incident into the display layer 110, providing light to the display layer 110 to realize an anti-peep mode, as illustrated in FIG. 7. When the display module 100 is in the anti-peep mode, as illustrated in FIG. 6, the heating electrode 250 is powered on. The heating electrode 250 heats the polymer material layer 220 to switch the polymer material layer 220 from the first state to the second state. The expanded polymer material layer 220 lifts up the isolation film 230 so that the isolation film 230 has a convex arc-shaped structure. The light provided by the backlight module 500 will first be emitted into the polymer material layer 220. Subsequently, under the action of the isolation film 230, the light rays corresponding to each partition 240 will be scattered. The light rays are diverged and emitted to spread throughout the entire partition 240 and even enter adjacent partitions 240. Then the light rays pass through the void layer 210 and the lower polarizer 130 to be incident into the display layer 110, providing light to the display layer 110 to form a wide viewing angle mode, as illustrated in FIG. 8. In this embodiment, the polymer material layer 220 includes a polymer material 221. The polymer material 221 is a material with a relatively high thermal expansion coefficient, so that the polymer material layer 220 can expand when the heating electrode 250 is heated by electricity. The polymer material 221 may be a polydimethylsiloxane (PDMS) transparent material, which not only has a relatively high thermal expansion performance, but also has good light transmittance, so that there will be no major loss when light passes through the polymer material layer 220. Of course, the polymer material 221 is not limited to polydimethylsiloxane transparent material. The polymer material 221 can also be other high thermal expansion coefficient materials. There are no limitations thereto, and designers can choose the design depending on the actual situation.

Furthermore, in order to prevent the polymer material layer 220 from switching from the first state to the second state due to the temperature generated when the backlight module 500 is operating when the display module 100 is in use, the light adjustment layer 200 further includes a first thermal insulation layer 270 and a second thermal insulation layer 280, as illustrated in FIG. 9. The first thermal insulation layer 270 is disposed on the side of the void layer 210 adjacent to the lower polarizer 130. The second thermal insulation layer 280 is disposed on the side of the polymer material layer 220 facing away from the void layer 210. When the display module 100 is in the wide viewing angle mode, the heating electrode 250 is in an energized state to heat the polymer material layer 220 to cause it to expand. At this time, the heat generated by the heating electrode 250 will be conducted to the void layer 210 through the polymer material layer 220, so that the heat generated by the heating electrode 250 may have a certain impact on the display layer 110. In this embodiment, on this basis, a first thermal insulation layer 270 is disposed on the side of the void layer 210 adjacent to the lower polarizer 130 to isolate the heat generated by the heating electrode 250 and prevent the heat generated by the heating electrode 250 from affecting the display layer 110 thus causing abnormal display. When the backlight module 500 provides light to the display module 100, the backlight module 500 will generate heat, and the heat will be conducted to the polymer material layer 220 to switch the polymer material layer 220 from the first state to the second state, thereby causing the display module 100 to be unable to stably switch between the wide viewing angle mode and the anti-peep mode. In this embodiment, on this basis, a second thermal insulation layer 280 is disposed on the side of the polymer material layer 220 facing away from the void layer 210. The second thermal insulation layer 280 insulates the heat generated when the backlight module 500 is operating, preventing the heat generated by the backlight module 500 from affecting the polymer material layer 220 and causing the display module 100 to switch from the anti-peep mode to the wide viewing angle mode. The first thermal insulation layer 270 and the second thermal insulation layer 280 are made of transparent materials to prevent the first thermal insulation layer 270 and the second thermal insulation layer 280 from blocking the light generated by the backlight module 500. It should be noted that the first thermal insulation layer 270 and the second thermal insulation layer 280 may be made of transparent indium tin oxide material to achieve good light transmittance and heat insulation.

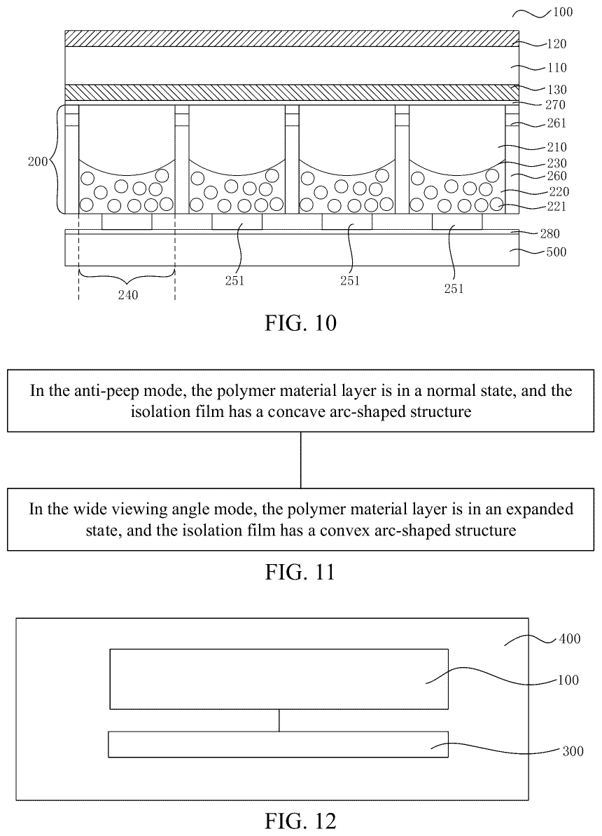

As illustrated in FIG. 10, the heating electrode 250 includes a plurality of sub-heating electrodes 251. Each of the sub-heating electrodes 251 is arranged corresponding to one of the partitions 240. The position of the sub-heating electrode 251 corresponds to the central part of the respective partition 240. That is, a plurality of sub-heating electrodes 251 arranged at intervals are used to heat the polymer material layer 220, so that when the heating electrode 250 heats the polymer material layer 220, the heating electrode 250 does not generate too much excess heat thus reducing the impact of the heat generated by the heating electrode 250 on the display layer 110. Furthermore, the position of each sub-heating electrode 251 is set corresponding to the central part of the respective partition 240. Therefore, when the sub-heating electrode 251 is energized and heated, the heat can be conducted to the central position of the polymer material layer 220 first, so that the central part of the polymer material layer 220 can switch to the second state faster than the edges of the polymer material layer 220, to lift up the central position of the isolation film 230 to form a convex arc-shaped structure, so that the display module 100 can be switched from the anti-peep mode to the wide viewing angle mode relatively more quickly.

As illustrated in FIG. 11, as a third embodiment of the present application, a driving method is disclosed, which is applied to the display module 100 as described in the above embodiment. The driving method includes the steps:
in the anti-peep mode, the polymer material layer 220 is in the first state, and the isolation film 230 has a concave arc-shaped structure;
in the wide viewing angle mode, the polymer material layer 220 is in the second state, and the isolation film 230 has an convex arc-shaped structure;
wherein when the display module 100 is in anti-peep mode, the polymer material layer 220 is in the first state, the isolation film 230 has a concave arc-shaped structure, and the light is emitted into the polymer material layer 220 and passes through the isolation film 230 to realize the anti-peep mode; when the display module 100 is in the wide viewing angle mode, the polymer material layer 220 is in the second state, the isolation film 230 has a convex arc-shaped structure, and after the light enters the polymer material layer 220, it is scattered under the action of the isolation film 230 to realize the wide viewing angle mode.

The driving method of this embodiment controls the polymer material layer 220 to switch between the first state and the second state, thereby controlling the isolation film 230 to switch between the concave arc-shaped structure and the convex arc-shaped structure, so that the display module 100 can be switched between the anti-peep mode and the wide viewing angle mode, allowing the user to switch between the anti-peep mode and the wide viewing angle mode according to his/her own viewing needs, meeting user needs and improving user experience.

As illustrated in FIG. 12, as a fourth embodiment of the present application, a display device 400 is disclosed. The display device 400 includes a driving circuit 300 and the display module 100 as described in the above embodiment. The driving circuit 300 drives the display module 100. The display device 400 of this embodiment can control the isolation film 230 to switch between a concave arc-shaped structure and a convex arc-shaped structure by controlling the polymer material layer 220 to switch between the first state and the second state, so that the display module 100 can be switched between the anti-peep mode and the wide viewing angle mode, allowing the user to switch between the anti-peep mode and the wide viewing angle mode according to his/her own viewing needs, meeting user needs and improving user experience.

It should be noted that the limitations of various operations involved in this solution will not be deemed to limit the order of the operations, provided that they do not affect the implementation of the specific solution, so that the operations written earlier may be executed earlier or they may also be executed later or even at the same time. As long as the solution can be implemented, they should all be regarded as falling in the scope of protection of this application.

The technical solutions of the present application can be widely used in various display panels, such as TN (Twisted Nematic) display panels, IPS (In-Plane Switching) display panels, VA (Vertical Alignment) display panels, and MVA (Multi-Domain Vertical Alignment) display panels panel. Of course, other types of display panels, such as OLED (Organic Light-Emitting Diode) display panels, may also be applicable to the above solutions.

It should be noted that the inventive concept of the present application can be formed into many embodiments, but the length of the application document is limited and so these embodiments cannot be enumerated one by one. The technical features can be arbitrarily combined to form a new embodiment, and the original technical effect may be enhanced after the various embodiments or technical features are combined.

The foregoing description is merely a further detailed description of this application with reference to some specific illustrative embodiments, and the specific implementations of this application are not to be construed to be limited to these illustrative embodiments. For those having ordinary skill in the technical field to which this application pertains, numerous deductions or substitutions may be made without departing from the concept of this application, which shall all be regarded as falling in the scope of protection of this application.

What is claimed is:

1. A display module, comprising:
a display layer;
an upper polarizer, arranged on a light-emitting surface side of the display layer; and
a lower polarizer, arranged on a light incident surface side of the display layer; and
a light adjustment layer, arranged on a side of the lower polarizer facing away from the display layer, wherein the light adjustment layer is divided into a plurality of partitions, wherein each of the plurality of partitions comprises a void layer and a polymer material layer, the void layer being arranged adjacent to the lower polarizer, and the polymer material layer being arranged on a side of the void layer facing away from the lower polarizer; wherein there is disposed an isolation film between the polymer material layer and the void layer;
wherein the polymer material layer comprises a first state and a second state, and the polymer material layer is operative to switch between the first state and the second state; wherein when the polymer material layer enters the first state, the isolation film has a concave arc-shaped structure, and the display module is in an anti-peep mode; when the polymer material layer is in the second state, the isolation film has a convex arc-shaped structure, and the display module enters a wide viewing angle mode.

2. The display module as recited in claim 1, wherein the light adjustment layer further comprises a heating electrode disposed on a side of the polymer material layer facing away from the void layer; wherein the heating electrode is operative to be energized to heat the polymer material layer so that the polymer material layer is operative to switch from the first state to the second state in response to being heated.

3. The display module as recited in claim 1, wherein there is disposed an separation wall between every two adjacent partitions, and wherein the isolation film in each of the plurality of partitions is fixed to the separation walls respectively arranged at left and right ends of the partition corresponding to the isolation film;
wherein the separation wall is made of a transparent material.

4. The display module as recited in claim 3, wherein there is defined a through hole in an area of each separation wall corresponding to the void layer.

5. The display module as recited in claim 2, wherein the light adjustment layer further comprises a first thermal insulation layer and a second thermal insulation layer, wherein the first thermal insulation layer is arranged on the side of the void layer facing the lower polarizer, and the second thermal insulation layer is arranged on the side of the polymer material layer facing away from the void layer; wherein the first thermal insulation layer and the second thermal insulation layer are each made of a transparent material.

6. The display module as recited in claim 2, wherein the heating electrode comprises a plurality of sub-heating electrodes, wherein the plurality of sub-heating electrodes are arranged in one-to-one correspondence with the plurality of partitions, and wherein each of the plurality of sub-heating electrodes is arranged at a position corresponding to a central portion of the respective partition.

7. The display module as recited in claim 1, wherein the polymer material layer comprises a polymer material, which is made of a material with a relatively high thermal expansion coefficient.

8. The display module as recited in claim 1, wherein the isolation film is a polyethylene terephthalate film.

9. The display module as recited in claim 3, wherein the separation wall is made of glass.

10. The display module as recited in claim 3, wherein both ends of the isolation film are fixed to the respective separation walls by gluing.

11. The display module as recited in claim 3, further comprising a gap layer that is disposed to cover the void layer and that is connected to an outside world, wherein air in the void layer is operative to be transferred through pores defined in the gap layer; wherein the gap layer is made of a porous material.

12. The display module as recited in claim 5, wherein the first thermal insulation layer and the second thermal insulation layer are each made of a transparent indium tin oxide material.

13. The display module as recited in claim 6, wherein the polymer material is a polydimethylsiloxane transparent material.

14. The display module as recited in claim 1, wherein the first state of the polymer material layer is a normal state, in which the polymer material layer is immobile and the isolation film has a concave arc-shaped structure; the second state of the polymer material layer is an expanded state, in which the polymer material layer expands to lift up the isolation film so that the isolation film has a convex arc-shaped structure.

15. A driving method, applied to a display module, the display module comprising a display layer, an upper polarizer arranged on a light-emitting surface side of the display layer, a lower polarizer arranged on a light incident surface side of the display layer, and a light adjustment layer disposed on a side of the lower polarizer facing away from the display layer; wherein the light adjustment layer is divided into a plurality of partitions, and wherein each of the plurality of partitions comprises a void layer and a polymer material layer, the void layer being arranged adjacent to the lower polarizer, and the polymer material layer being arranged on a side of the void layer facing away from the lower polarizer; wherein there is disposed an isolation film between the polymer material layer and the void layer; wherein the polymer material layer comprises a first state and a second state, and the polymer material layer is operative to switch between the first state and the second state; wherein when the polymer material layer is in the first state, the isolation film has a concave arc-shaped structure, and the display module enters an anti-peep mode; when the polymer material layer is in the second state, the isolation film has a convex arc-shaped structure, and the display module enters a wide viewing angle mode; the driving method comprising the following operations:
in the anti-peep mode, entering, by the polymer material layer, the first state, and forming a concave arc-shaped structure by the isolation film;
in the wide viewing angle mode, entering, by the polymer material layer, the second state, and forming a convex arc-shaped structure by the isolation film;
wherein when the display module is in the anti-peep mode, the polymer material layer is in the first state, the isolation film has the concave arc-shaped structure, and light is emitted into the polymer material layer and then is converged under the action of the isolation film to realize the anti-peep mode; when the display module is in the wide viewing angle mode, the polymer material layer is in the second state, the isolation film has a convex arc-shaped structure, and light is emitted into the polymer material layer and then scattered under the action of the isolation film thus realizing the wide viewing angle mode.

16. The driving method as recited in claim 15, wherein the light adjustment layer further comprises a heating electrode disposed on a side of the polymer material layer facing away from the void layer; wherein the heating electrode is operative to be energized to heat the polymer material layer so that the polymer material layer is operative to switch from the first state to the second state in response to being heated.

17. The driving method as recited in claim 16, wherein the light adjustment layer further comprises a first thermal insulation layer and a second thermal insulation layer, the first thermal insulation layer being disposed on the side of the void layer facing the lower polarizer, and the second thermal insulation layer being disposed on a side of the polymer material layer facing away from the void layer; wherein the first thermal insulation layer and the second thermal insulation layer are each made of a transparent material.

18. The driving method as recited in claim 16, wherein the heating electrode comprises a plurality of sub-heating electrodes, wherein the plurality of sub-heating electrodes are arranged in one-to-one correspondence with the plurality of partitions, and wherein each of the plurality of sub-heating electrodes is arranged at a position corresponding to a central portion of the respective partition.

19. A display device, comprising a display module and a driving circuit configured to drive the display module, the display module comprising a display layer, an upper polarizer arranged on a light-emitting surface side of the display layer, a lower polarizer arranged on a light incident surface side of the display layer, and a light adjustment layer arranged on a side of the lower polarizer facing away from the display layer; wherein the light adjustment layer is divided into a plurality of partitions, and wherein each of the plurality of partitions comprises a void layer and a polymer material layer, the void layer being arranged adjacent to the lower polarizer, and the polymer material layer being arranged on a side of the void layer facing away from the lower polarizer; wherein there is disposed an isolation film between the polymer material layer and the void layer; wherein the polymer material layer comprises a first state and a second state, and the polymer material layer is operative to switch between the first state and the second state; wherein when the polymer material layer is in the first state, the isolation film has a concave arc-shaped structure, and the display module is in an anti-peep mode; when the polymer material layer is in the second state, the isolation film has a convex arc-shaped structure, and the display module is in a wide viewing angle mode.

20. The display device as recited in claim 19, wherein the light adjustment layer further comprises a heating electrode disposed on a side of the polymer material layer facing away from the void layer; wherein the heating electrode is operative to be energized to heat the polymer material layer so that the polymer material layer is operative to switch from the first state to the second state in response to being heated.
